(19) United States
(12) Patent Application Publication
(10) Pub. No.: US 2024/0354189 A1
(43) Pub. Date: Oct. 24, 2024

(54) ERROR CODE CORRECTION COHERENCY CHECKS FOR TERNARY CELL-BASED MEMORY DEVICES

(71) Applicant: Micron Technology, Inc., Boise, ID (US)

(72) Inventors: Christophe Vincent Antoine Laurent, Agrate Brianza (MB) (IT); Riccardo Muzzetto, Arcore (MB) (IT)

(21) Appl. No.: 18/608,758

(22) Filed: Mar. 18, 2024

Related U.S. Application Data
(60) Provisional application No. 63/496,780, filed on Apr. 18, 2023.

(51) Int. Cl. G06F 11/10

(52) U.S. Cl. CPC G06F 11/1004

(57) ABSTRACT

In some implementations, the techniques described herein relate to a method including: receiving a codeword, the codeword having a first portion and a second portion, the first portion including user data and the second portion including synthesized data; detecting, using an ECC engine, at least one error in the codeword at a first position; and signaling an error misdetection when the first position is within the second portion.

### RELATED APPLICATIONS

The present application claims priority to Prov. U.S. Pat. App. Ser. No. 63/496,780 filed Apr. 18, 2023, the entire disclosures of which application are hereby incorporated herein by reference.

### TECHNICAL FIELD

At least some embodiments disclosed herein relate to memory systems in general and, more particularly but not limited to, techniques of configuring memory cells to store data.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

A memory device can include a memory integrated circuit having one or more arrays of memory cells formed on an integrated circuit die of semiconducting material. A memory cell is the smallest unit of memory that can be individually used or operated upon to store data. In general, a memory cell can store one or more bits of data.

Different types of memory cells have been developed for memory integrated circuits, such as random-access memory (RAM), read-only memory (ROM), dynamic random access memory (DRAM), static random access memory (SRAM), synchronous dynamic random access memory (SDRAM), phase change memory (PCM), magneto random access memory (MRAM), negative-or (NOR) flash memory, electrically erasable programmable read-only memory (EEPROM), flash memory, etc.

Some integrated circuit memory cells are volatile and require power to maintain data stored in the cells. Examples of volatile memory include Dynamic Random-Access Memory (DRAM) and Static Random-Access Memory (SRAM).

Some integrated circuit memory cells are non-volatile and can retain stored data even when not powered. Examples of non-volatile memory include flash memory, Read-Only Memory (ROM), Programmable Read-Only Memory (PROM), Erasable Programmable Read-Only Memory (EPROM) and Electronically Erasable Programmable Read-Only Memory (EEPROM) memory, etc. Flash memory includes negative-and (NAND) type flash memory or a negative-or (NOR) type flash memory. A NAND memory cell is based on a NAND logic gate; and a NOR memory cell is based on a NOR logic gate.

Cross-point memory (e.g., 3D XPoint memory) uses an array of non-volatile memory cells. The memory cells in cross-point memory are transistor-less. Each of such memory cells can have a selector device and optionally a phase-change memory device that are stacked together as a column in an integrated circuit. Memory cells of such columns are connected in the integrated circuit via two layers of wires running in directions that are perpendicular to each other. One of the two layers is above the memory cells; and the other layer is below the memory cells. Thus, each memory cell can be individually selected at a cross point of two wires running in different directions in two layers. Cross point memory devices are fast and non-volatile and can be used as a unified memory pool for processing and storage.

A non-volatile integrated circuit memory cell can be programmed to store data by applying a voltage or a pattern of voltage to the memory cell during a program/write operation. The program/write operation sets the memory cell in a state that corresponds to the data being programmed/stored into the memory cell. The data stored in the memory cell can be retrieved in a read operation by examining the state of the memory cell. The read operation determines the state of the memory cell by applying a voltage and determining whether the memory cell becomes conductive at a voltage corresponding to a pre-defined state.

### BRIEF DESCRIPTION OF THE DRAWINGS

The embodiments are illustrated by way of example and not limitation in the figures of the accompanying drawings in which like references indicate similar elements.

FIG. 1 shows a memory device configured with a programming manager according to one embodiment.

FIG. 2 shows a memory cell with a bitline driver and a wordline driver configured to apply voltage pulses according to one embodiment.

FIG. 3 illustrates distributions of threshold voltages of memory cells each configured to represent one of three predetermined values according to one embodiment.

FIGS. 4 to 6 illustrate voltage pulses applied to configure memory cells to store data according to some embodiments.

FIG. 7A illustrates the segmentation of a message into two codewords.

FIG. 7B illustrates a scenario where physical errors in a ternary cell can impact a decoding process.

FIGS. 8A and 8B illustrate a scenario in which an ECC engine improperly recommends an error correction.

FIG. 9 is a flow diagram illustrating a method for detecting an incorrect error position in an ECC algorithm executing on an extended ECC codeword.

FIG. 10 is a flow diagram illustrating a method for increasing the correction power of an ECC engine using correlations between two codewords.

FIG. 11 is a flow diagram illustrating a method for detecting an incorrect error detection in an ECC algorithm executing on an extended ECC codeword.

FIG. 12 illustrates an example computing system having a memory sub-system in accordance with some embodiments of the present disclosure.

FIG. 13 is a block diagram of an example computer system in which embodiments of the present disclosure can operate.

### DETAILED DESCRIPTION

At least some aspects of the disclosure are directed to a memory sub-system configured to correct errors when reading one or more self-selecting memory cells.

The memory sub-system can be used as a storage device and/or a memory module. Examples of storage devices, memory modules, and memory devices are described below in conjunction with the following figures. A host system can utilize a memory sub-system that includes one or more components, such as memory devices that store data. The host system can provide data to be stored at the memory sub-system and can request data to be retrieved from the memory sub-system.

An integrated circuit memory cell, such as a memory cell in a flash memory or a memory cell in a cross-point memory, can be programmed to store data by the way of its state at a voltage applied across the memory cell. For example, if a memory cell is configured or programmed in such a state that allows a substantial current to pass the memory cell at a voltage in a predefined voltage region, the memory cell is considered to have been configured or programmed to store a first bit value (e.g., one or zero); and otherwise, the memory cell is storing a second bit value (e.g., zero or one). Optionally, a memory cell can be configured or programmed to store more than one bit of data by being configured or programmed to have a threshold voltage in one of more than two separate voltage regions.

The threshold voltage of a memory cell is such that when the magnitude of the voltage applied across the memory cell is increased to above the threshold voltage, the memory cell changes rapidly or abruptly, snaps, or jumps from a non-conductive state to a conductive state. The non-conductive state allows a small leak current to go through the memory cell; and in contrast, the conductive state allows more than a threshold amount of current to go through. Thus, a memory device can use a sensor to detect the change or determine the conductive/non-conductive state of the memory device at one or more applied voltages, to evaluate or classify the level of the threshold voltage of the memory cell and thus its stored data.

The threshold voltage of a memory cell being configured or programmed to be in different voltage regions can be used to represent different data values stored in the memory cell. For example, the threshold voltage of the memory cell can be programmed to be in any of three predefined voltage regions; and each of the regions can be used to represent the bit values of a different two-bit data item. Thus, when given a two-bit data item, one of the three voltage regions can be selected based on a mapping between two-bit data items and voltage regions; and the threshold voltage of the memory cell can be adjusted, programmed, or configured to be in the selected voltage region to represent or store the given two-bit data item. To retrieve, determine, or read the data item from the memory cell, one or more read voltages can be applied across the memory cell to determine which of the three voltage regions contain the threshold voltage of the memory cell. The identification of the voltage region that contains the threshold voltage of the memory cell provides the two-bit data item that has been stored, programmed, or written into the memory cell.

For example, a memory cell can be configured or programmed to store a one-bit data item in a Single Level Cell (SLC) mode, or a two-bit data item in a Multi-Level Cell (MLC) mode, or a three-bit data item in a Triple Level Cell (TLC) mode, or a four-bit data item in Quad-Level Cell (QLC) mode, or a five-bit data item in a Penta-Level Cell (PLC) mode.

The threshold voltage of a memory cell can change or drift over a period of time, usage, and/or read operations, and in response to certain environmental factors, such as temperate changes. The rate of change or drift can increase as the memory cell ages. The change or drift can result in errors in determining, retrieving, or reading the data item back from the memory cell.

Random errors in reading memory cells can be detected and corrected using redundant information. Data to be stored into memory cells can be encoded to include redundant information to facilitate error detection and recovery. When data encoded with redundant information is stored in a memory sub-system, the memory sub-system can detect errors in data represented by the voltage regions of the threshold voltages of the memory cells and/or recover the original data that is used to generate the data used to program the threshold voltages of the memory cells. The recovery operation can be successful (or have a high probability of success) when the data represented by the threshold voltages of the memory cells and thus retrieved directly from the memory cells in the memory sub-system contains fewer errors, or the bit error rate in the retrieved data is low and/or when the amount of redundant information is high. For example, error detection and data recovery can be performed using techniques such as Error Correction Code (ECC), Low-Density Parity-Check (LDPC) code, etc., as will be discussed in more detail herein.

It is a challenge to efficiently program a memory cell into an intermediate state representing by its threshold voltage being in a voltage region assigned to represent a value, separate from a high voltage region and a low voltage region. It is relatively easy to program the threshold voltage of a memory cell into the high voltage region and the low voltage region. It is difficult to precisely program the threshold voltage of the memory cell into an intermediate region between, but having no overlapping with, the high voltage region and the low voltage region.

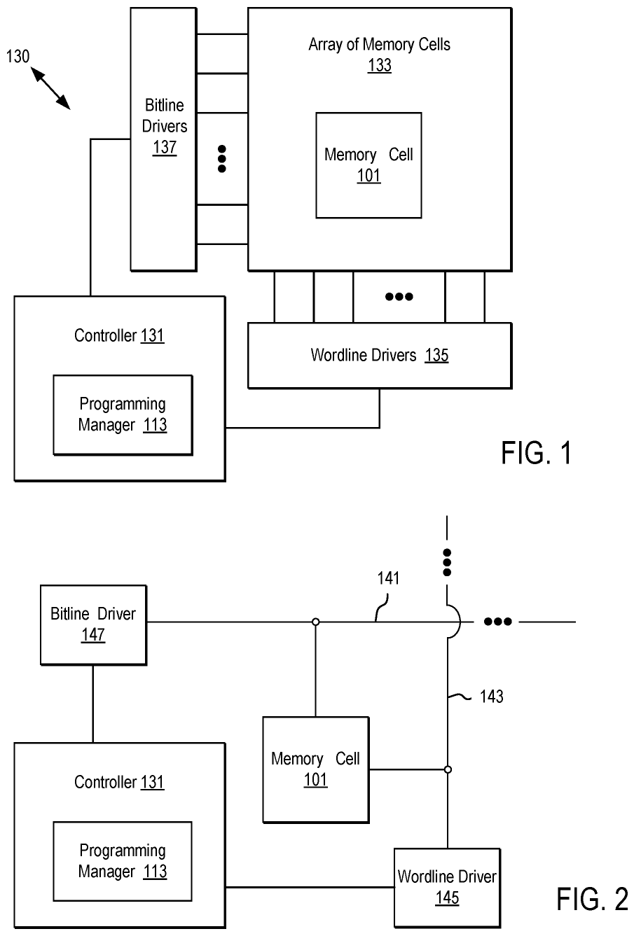

FIG. 1 shows a memory device 130 configured with a programming manager 113 according to one embodiment.

In FIG. 1, the memory device 130 includes an array 133 of memory cells, such as a memory cell 101. An array 133 can be referred to as a tile; and a memory device (e.g., 130) can have one or more tiles. Different tiles can be operated in parallel in a memory device (e.g., 130).

For example, the memory device 130 illustrated in FIG. 1 can have a cross-point memory having at least the array 133 of memory cells (e.g., 101).

In some implementations, the cross point memory uses a memory cell 101 that has an element (e.g., a sole element) acting both as a selector device and a memory device. For example, the memory cell 101 can use a single piece of alloy with variable threshold capability. The read/write operations of such a memory cell 101 can be based on thresholding the memory cell 101 while inhibiting other cells in sub-threshold bias, in a way similar to the read/write operations for a memory cell having a first element acting as a selector device and a second element acting as a phase-change memory device that are stacked together as a column. A selector device usable to store information can be referred to as a selector/memory device.

The memory device 130 of FIG. 1 includes a controller 131 that operates bitline drivers 137 and wordline drivers 135 to access the individual memory cells (e.g., 101) in the array 133.

For example, each memory cell (e.g., 101) in the array 133 can be accessed via voltages driven by a pair of a bitline driver 147 and a wordline driver 145, as illustrated in FIG. 2.

The controller 131 includes a programming manager 113 configured to implement a counter-controlled programming pulse. The programming manager 113 can be implemented, for example, via logic circuits and/or microcodes/instructions. For example, to program the threshold voltage of the memory cell 101 into a second voltage region adjacent to a first voltage region, the programming manager 113 can instruct the bitline drivers 137 and the wordline drivers 135 to initially apply a voltage pulse configured to program the threshold voltage of the memory cell 101 into the first voltage region. After the completion of the initial voltage pulse, the programming manager 113 further instructs the bitline drivers 137 and the wordline drivers 135 to apply a subsequent voltage pulse to move the threshold voltage of the memory cell 101 from the first voltage region to the adjacent second voltage region that is separate from the first voltage region. The magnitude of the subsequent voltage pulse is dynamically controlled for a set of memory cells that are to be read together for a data item (e.g., a codeword for error detection and data recovery using an Error Correction Code (ECC)). The programming manager 113 can instruct the bitline drivers 137 and the wordline drivers 135 to increase the applied magnitude in increments until each and every of the memory cells to be programmed to the second voltage regions are conductive under the applied magnitude. For example, a counter can be used to count the number of memory cells that are in a conductive state under the current increment of the magnitude. When the magnitude is increased to a level of increment that causes the value in the counter to be equal to the number of memory cells in the codeword to be programmed to the adjacent second voltage region, no further increment is applied to the magnitude of the subsequent voltage pulse applied to the memory cells.

FIG. 2 shows a memory cell 101 with a bitline driver 147 and a wordline driver 145 configured to apply voltage pulses according to one embodiment. For example, the memory cell 101 can be a typical memory cell 101 in the memory cell array 133 of FIG. 1.

The bitline driver 147 and the wordline driver 145 of FIG. 2 are controlled by the programming manager 113 of the controller 131 to selectively apply one or more voltages pulses to the memory cell 101.

The bitline driver 147 and the wordline driver 145 can apply voltages of different polarities on the memory cell 101.

For example, in applying one polarity of voltage (e.g., positive polarity), the bitline driver 147 drives a positive voltage relative to the ground on a bitline 141 connected to a row of memory cells in the array 133; and the wordline driver 145 drives a negative voltage relative to the ground on a wordline 143 connected to a column of memory cells in the array 133.

In applying the opposite polarity of voltage (e.g., negative polarity), the bitline driver 147 drives a negative voltage on the bitline 141; and the wordline driver 145 drives a positive voltage on the wordline 143.

The memory cell 101 is in both the row connected to the bitline 141 and the column connected to the wordline 143. Thus, the memory cell 101 is subjected to the voltage difference between the voltage driven by the bitline driver 147 on the bitline 141 and the voltage driven by the wordline driver 145 on the wordline 143.

In general, when the voltage driven by the bitline driver 147 is higher than the voltage driven by the wordline driver 145, the memory cell 101 is subjected to a voltage in one polarity (e.g., positive polarity); and when the voltage driven by the bitline driver 147 is lower than the voltage driven by the wordline driver 145, the memory cell 101 is subjected to a voltage in the opposite polarity (e.g., negative polarity).

In some implementations, the memory cell 101 is a self-selecting memory cell implemented using a selector/memory device. The selector/memory device has a chalcogenide (e.g., chalcogenide material and/or chalcogenide alloy). For example, the chalcogenide material can include a chalcogenide glass such as, for example, an alloy of selenium (Se), tellurium (Te), arsenic (As), antimony (Sb), carbon (C), germanium (Ge), and silicon (Si). A chalcogenide material can primarily have selenium (Se), arsenic (As), and germanium (Ge) and be referred to as SAG-alloy. SAG-alloy can include silicon (Si) and be referred to as SiSAG-alloy. In some embodiments, the chalcogenide glass can include additional elements such as hydrogen (H), oxygen (O), nitrogen (N), chlorine (Cl), or fluorine (F), each in atomic or molecular forms. The selector/memory device has a top side and a bottom side. A top electrode is formed on the top side of the selector/memory device for connecting to a bitline 141; and a bottom electrode is formed on the bottom side of the selector/memory device for connecting to a wordline 143. For example, the top and bottom electrodes can be formed of a carbon material. For example, a chalcogenide material of the memory cell 101 can take the form of a crystalline atomic configuration or an amorphous atomic configuration. The threshold voltage of the memory cell 101 can be dependent on the ratio of the material in the crystalline configuration and the material of the amorphous configuration in the memory cell 101. The ratio can change under various conditions (e.g., having currents of different magnitudes and directions going through the memory cell 101).

A self-selecting memory cell 101, having a selector/memory device, can be programmed to have a threshold voltage window. The threshold voltage window can be created by applying programming pulses with opposite polarity to the selector/memory device. For example, the memory cell 101 can be biased to have a positive voltage difference between two sides of the selector/memory device and alternatively, or to have a negative voltage difference between the same two sides of the selector/memory device. When the positive voltage difference is considered in positive polarity, the negative voltage difference is considered in negative polarity that is opposite to the positive polarity. Reading can be performed with a given/fixed polarity. When programmed, the memory cell has a low threshold (e.g., lower than the cell that has been reset, or a cell that has been programmed to have a high threshold), such that during a read operation, the read voltage can cause a programmed cell to snap and thus become conductive while a reset cell remains non-conductive.

For example, to program the voltage threshold of the memory cell 101, the bitline driver 147 and the wordline driver 145 can drive a pulse of voltage onto the memory cell 101 in one polarity (e.g., positive polarity) to snap the memory cell 101 such that the memory cell 101 is in a conductive state. While the memory cell 101 is conductive, the bitline driver 147 and the wordline driver 145 continue driving the programming pulse to change the threshold voltage of the memory cell 101 towards a voltage region that represents the data or bit value(s) to be stored in the memory cell 101.

The controller 131 can be configured in an integrated circuit having a plurality of decks of memory cells. Each deck can be sandwiched between a layer of bitlines, a layer of wordlines; and the memory cells in the deck can be arranged in an array 133. A deck can have one or more arrays or tiles. Adjacent decks of memory cells may share a layer of bitlines (e.g., 141) or a layer of wordlines (e.g., 143). Bitlines are arranged to run in parallel in their layer in one direction; and the wordlines are arranged to run in parallel in their layer in another direction orthogonal to the direction of the bitlines. Each of the bitlines is connected to a row of memory cells in the array; and each of the wordlines is connected to a column of memory cells in the array. Bitline drivers 137 are connected to bitlines in the decks; and wordline drivers 135 are connected to wordlines in the decks. Thus, a typical memory cell 101 is connected to a bitline driver 147 and a wordline driver 145.

The threshold voltage of a typically memory cell 101 is configured to be sufficiently high such that when only one of its bitline driver 147 and wordline driver 145 drives a voltage in either polarity while the other voltage driver holds the respective line to the ground, the magnitude of the voltage applied across the memory cell 101 is insufficient to cause the memory cell 101 to become conductive. Thus, addressing the memory cell 101 can be performed via both of its bitline driver 147 and wordline driver 145 driving a voltage in opposite polarity relative to the ground for operating/selecting the memory cell 101. Other memory cells connected to the same wordline driver 145 can be de-selected by their respective bitline drivers holding the respective bitlines to the ground; and other memory cells connected to the same bitline driver can be de-selected by their respective wordline drives holding the respective wordlines to the ground.

A group of memory cells (e.g., 101) connected to a common wordline driver 145 can be selected for parallel operation by their respective bitline drivers (e.g., 147) driving up the magnitude of voltages in one polarity while the wordline driver 145 is also driving up the magnitude of a voltage in the opposite polarity. Similarly, a group of memory cells connected to a common bitline driver 147 can be selected for parallel operation by their respective wordline drivers (e.g., 145) driving voltages in one polarity while the bitline driver 147 is also driving a voltage in the opposite polarity.

At least some examples are disclosed herein in reference to a cross-point memory having self-selecting memory cells. Other types of memory cells and/or memory having similar threshold voltage characteristics can also be used. For example, memory cells each having a selector device and a phase-change memory device and/or flash memory cells can also be used in at least some embodiments.

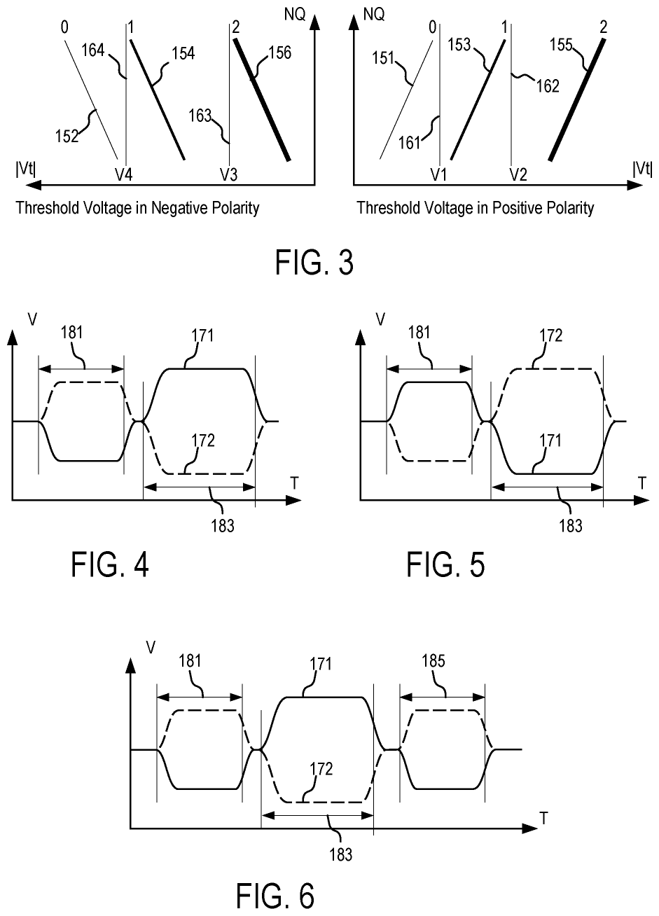

FIG. 3 illustrates distributions of threshold voltages of memory cells each configured to represent one of three predetermined values according to one embodiment. For example, the programming manager 113 of FIGS. 1 and 2 can be used to program the threshold voltage of a memory cell 101 such that the probability distribution of its threshold voltage is as illustrated in FIG. 3.

The probability distribution of the threshold voltage of a memory cell can be illustrated via a normal quantile (NQ) plot, as in FIG. 3. When a probability distribution (e.g., 151) of threshold voltage programmed in a region is a normal distribution (also known as Gaussian distribution), its normal quantile (NQ) plot is seen as aligned on a straight line (e.g., distribution 151).

A self-selecting memory cell (e.g., 101) can have a threshold voltage in negative polarity and a threshold voltage in positive polarity. When a voltage applied on the memory cell 101 in either polarity is increased in magnitude up to its threshold voltage in the corresponding polarity, the memory cell (e.g., 101) snaps from a non-conductive state to a conductive state.

The threshold voltage of a memory cell 101 in negative polarity and the threshold voltage of the memory cell 101 in positive polarity can have different magnitudes. Memory cells programmed to have large magnitudes in threshold voltages in positive polarity can have small magnitudes in threshold voltages in negative polarity; and memory cells programmed to have small magnitudes in threshold voltages in positive polarity can have large magnitudes in threshold voltages in negative polarity.

For example, a memory cell 101 can be programmed to have a small magnitude in threshold voltage according to distribution 151 in the positive polarity to represent a value (e.g., zero); and as a result, its threshold voltage has a large magnitude according to distribution 152 in the negative polarity to represent the same value (e.g., zero). The threshold voltages of the memory cell 101 in the positive and negative polarities can be programmed to the distributions 151 and 152 by applying a voltage pulse in the positive polarity (e.g., as illustrated in FIG. 4) to place the memory cell 101 in a conductive state and to cause a predetermined level of current (e.g., 120 μA) to go through the memory cell 101.

Alternatively, the memory cell 101 can be programmed to have a smaller magnitude in threshold voltage according to distribution 156 in the negative polarity to represent another value (e.g., two); and as a result, its threshold voltage has a large magnitude according to distribution 155 in the positive polarity to represent the same value (e.g., two). The threshold voltages of the memory cell 101 in the positive and negative polarities can be programmed to the distributions 155 and 156 by applying a voltage pulse in the negative polarity (e.g., as illustrated in FIG. 5) to place the memory cell 101 in a conductive state and to cause a predetermined level of current (e.g., 120 μA) to go through the memory cell 101.

The state of having threshold voltages in the distributions 151 and 152 and the state of having threshold voltages in the distributions 155 and 156 are relatively easy to obtain. The programming of the memory cell 101 to such two states can be implemented using voltage pulses illustrated in FIGS. 4 and 5. The voltage regions of the distributions 151, 152, 155 and 156 are controlled primarily by the polarity of the programming voltage pulses and the level of current passing through the memory cell 101 near the end of the programming voltage pulses.

To facilitate the storing of more than one bit of data per memory cell, the memory cell 101 can be programmed into an intermediate state between the two states.

For example, the memory cell 101 can be programmed to have a medium magnitude in threshold voltage according to distribution 153 in the positive polarity to represent a further value (e.g., one); and as a result, its threshold voltage has a magnitude according to distribution 154 in the negative polarity to represent the same value (e.g., one). The threshold voltages of the memory cell 101 in the positive and negative polarities can be programmed to the distributions 153 and 154 by applying a voltage pulse to move the threshold voltages of the memory from the distributions 151 and 152, or from the distributions 155 and 156.

In some implementations, more than one intermediate state can be programmed in a similar way such that the threshold voltage in the positive polarity is in the voltage region of one of four distributions and the threshold voltage in the negative polarity is in the voltage region of one of four distributions. Such four states can be used to represent a two-bit data item stored in the memory cell 101.

In FIG. 3, the voltage distributions 151, 153 and 155 in the positive polarity are separated by read voltage V1 161 and read voltage V2 162. Thus, whether the threshold voltage of the memory cell 101 in the positive polarity is in the distribution 151 can be determined by testing whether the memory cell 101 is conductive at the read voltage V1 161 in the positive polarity; and whether the threshold voltage of the memory cell 101 in the positive polarity is in the distribution 155 can be determined by testing whether the memory cell 101 is non-conductive at the read voltage V2 162 in the positive polarity. If the threshold voltage of the memory cell 101 in the positive polarity is in neither the distribution 151 nor the distribution 155, it is in the distribution 153 representative of the corresponding value (e.g., one).

Similarly, in FIG. 3, the distributions 152, 154 and 156 in the negative polarity are separated by the read voltage V3 163 and read voltage V4 164. Thus, whether the threshold voltage of the memory cell 101 in the negative polarity is in the distribution 156 can be determined by testing whether the memory cell 101 is conductive at the read voltage V3 163 in the negative polarity; and whether the threshold voltage of the memory cell 101 in the negative polarity is in the distribution 152 can be determined by testing whether the memory cell 101 is non-conductive at the read voltage V4 164 in the negative polarity. If the threshold voltage of the memory cell 101 in the negative polarity is in neither the distribution 152 nor the distribution 156, it is in the distribution 154 representative of the corresponding value (e.g., one).

Thus, the determination of the state and thus the value represented by the state (e.g., region of threshold voltage) can be performed by reading the memory cell 101 in the positive polarity using the read voltages V1 and V2, or reading the memory cell 101 in the negative polarity using the read voltages V3 and V4, or a combination of reading the memory cell 101 in the negative polarity using read voltage V3 and in the positive polarity using read voltage V1.

In the following embodiments, a codeword can be read from a memory device. This single codeword may be physically stored in the types of ternary cells described above. In general, pairs of ternary cells can be read together to generate a three-digit binary value. In the various implementations, it may be beneficial to segment a codeword based on bit positions of these individual three-digit binary values.

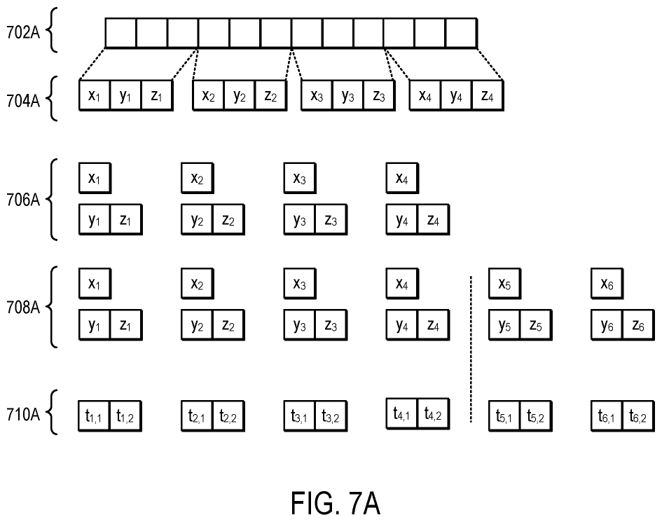

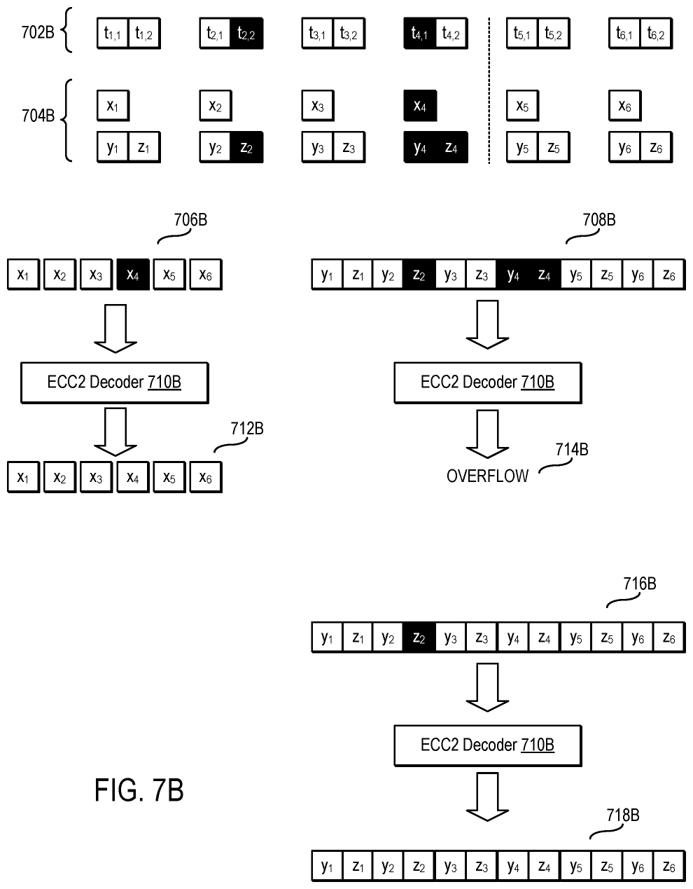

FIG. 7A illustrates the segmentation of a message into two codewords.

In the illustrated embodiment, user data 702A comprises a set of k bits. The specific number of k is not limiting and the specifically illustrated size of the user data 702A is not limiting. In general, user data 702A may comprise any type of binary data.

In a first step, the user data 702A is chunked into three-bit chunks to form chunked user data 704A. In some implementations, the value of three is determined by the underlying memory cell technology. For example, as used herein, a given memory device may utilize three-state ternary cells and the choice of three for chunking may be based on this underlying physical characteristic of the memory cells. Certainly, other types of memory cells may change the chunking value, however a value of three is used herein and ternary cells are also used herein. Formally, the user data 702A may be represented as:

$${CW}_{x y z} = {x}_{1} {y}_{1} {z}_{1} {x}_{2} {y}_{2} {z}_{2} … {x}_{n} {y}_{n} {z}_{n}$$

Next, in state 706A, the chunked user data 704A is split into two separate codewords:

$${CW}_{x} = {x}_{1} {x}_{2} … {x}_{n} ; and \\ {CW}_{y z} = {y}_{1} {z}_{1} {y}_{2} {z}_{2} … {y}_{n} {z}_{n}$$

In state 708A, parity bits can be computed for each codeword independently. Thus, CWₓ can have its own associated parity bits (x₅x₆) while CW_{yz} can have its own parity bits (y₅z₅y₆z₆). Finally, the codewords and parity bits can be encoded into ternary values 710A. As illustrated, each ternary value is formed from a bit of CWₓ and two bits from CW_{yz}. Notably, as illustrated, there is a correspondence between the values of CWₓ and CW_{yz} due to the construction of the codewords. In some implementations, an encoding table can be used to map three-bit strings to ternary cell combinations. Examples of such encoding tables are provided in commonly-owned application bearing attorney docket number 120426-063400, which is incorporated by reference in its entirety.

During reading and decoding from ternary cells, physical errors in a ternary cell can impact the decoding process. One example of this problem is depicted in FIG. 7B. As illustrated, pairs of ternary cells 702B corresponding to a binary codeword are retrieved. Further, two ternary memory cells (t_{2,2} and t_{4,1}) experienced read errors caused by the underlying physical memory structure (described more fully in commonly-owned application bearing attorney docket number 120426-063400, which is incorporated by reference in its entirety). During decoding, these physical errors may propagate to errors in the binary decoded values 704B. Specifically, the error in t_{2,2} causes one error in CW_{yz} (at z₂) while the error in t_{4,1} causes three errors, one in CWₓ (x₄) and two in CW_{yz} (y₄ and z₄).

In some memory devices, a single ECC engine may be used. As illustrated, an ECC2 decoder 710B is used, such as a BCH-2 engine, however the specific algorithm used is not limiting. As illustrated, both CWₓ 706B and CW_{yz} 708B are input into the ECC2 decoder 710B. In this specific example, CWₓ 706B is properly decoded since it includes one error and does not overflow the ECC2 decoder 710B. However, the ECC2 decoder 710B overflows 714B when detecting and/or correcting errors in CW_{yz} 708B since it includes three errors. Specifically, the resulting syndrome generated by ECC2 decoder 710B may result in an arbitrary correction resulting in incorrect data. If the decoded CWₓ 712B were combined with the output of decoding CW_{yz} 708B, the resulting data would be incorrect.

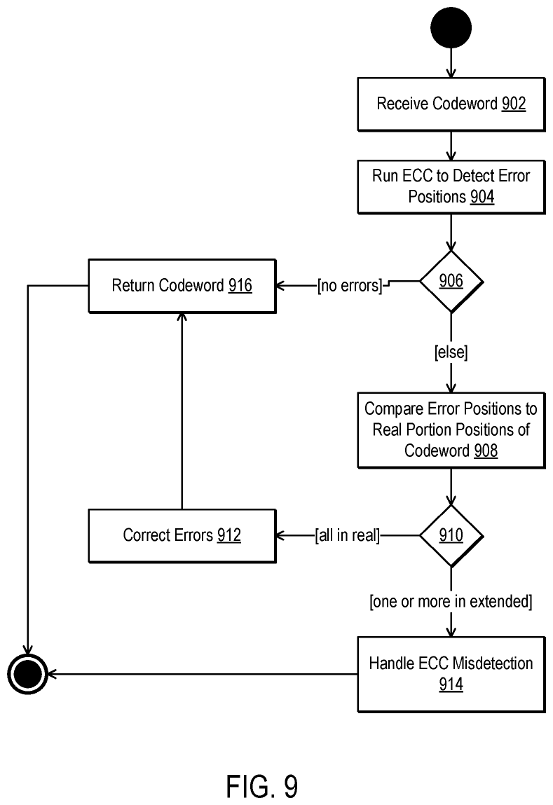

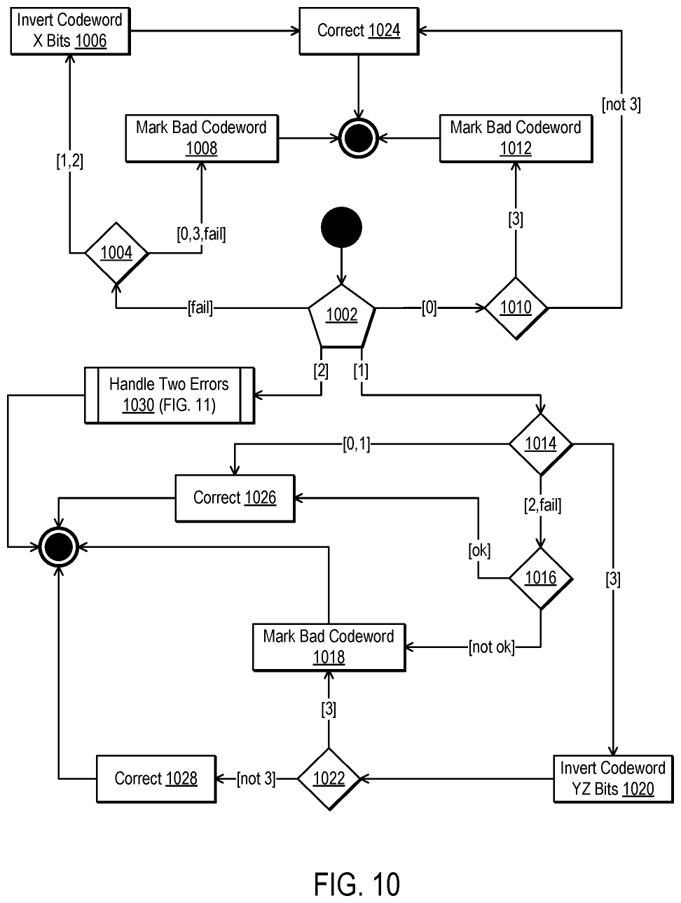

However, since the construction of ternary cells from two codewords is used, aspects of CWₓ can be used to adjust CW_{yz} prior to decoding. For example, the ECC engine can identify any CW_{y} error positions that have corresponding CW_{yz} errors and invert those bits. The result of this is shown in partially-inverted codeword 716B. Here, since x₄ included an error and the corresponding y₄ and z₄ bits included errors, the ECC engine can invert y₄ and z₄ bits and attempt to decode the partially-inverted codeword 716B. Since the partially-inverted codeword 716B only includes one error, the ECC2 decoder 710B can decode the codeword (result 718B). The result 718B can then be combined with decoded CWₓ 712B to generate a correctly decoded value. Thus, the foregoing example can leverage information from CWₓ to correct errors in CW_{yz}. Certainly, the number of errors in both CWₓ and CW_{yz} may vary and FIGS. 9 and 10 provide a complete process to account for various scenarios of errors.

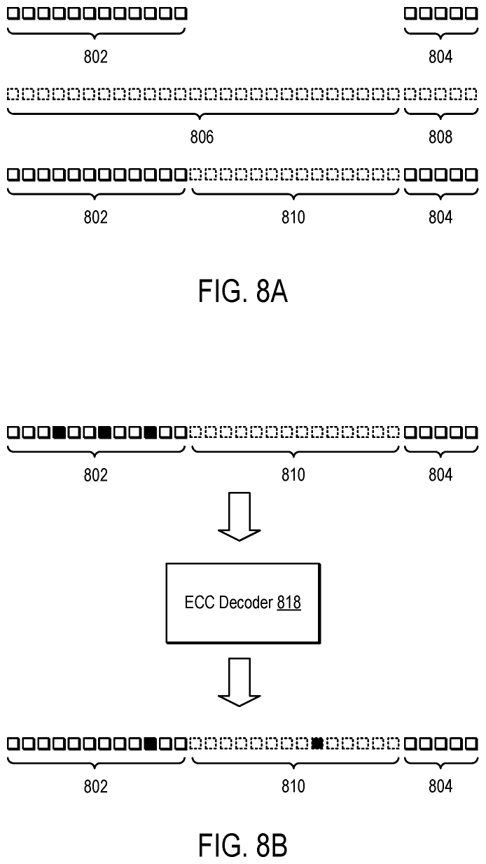

FIGS. 8A and 8B illustrate a scenario in which an ECC engine improperly recommends an error correction.

In the illustrated embodiment, a codeword may include a real portion 802 and a parity portion 804. The real portion 802 generally refers to user data stored in a memory device, while the associated parity portion 804 comprises redundant parity data generated during write by an ECC engine. The specific sizes of real portion 802 and parity portion 804 are not limiting.

A given ECC code (e.g., BCH Code) may have a fixed size. For example, the illustrated BCH code includes a user data portion 806 and a parity portion 808. In some implementations, the size of the ECC code may be selected to be the smallest size capable of storing the real portion 802 of the codeword described above. For example, the size of the ECC code may be defined as 2^{m}−1, where m is such that the number of user data bits plus the number of parity bits (t*m) is less than or equal to 2^{m-1}, and t represents the error correction capability. As illustrated, the total size of the ECC code is larger than the size of the real portion 802 and parity portion 804. Indeed, while the parity portion 804 is equal in size to the parity portion 808, the user data portion 806 is larger than real portion 802.

In some implementations, it may be desired to reuse an ECC engine, regardless of the user data size (e.g., to reduce the hardware complexity of a memory controller). However, real portion 802 and parity portion 804 will generally not be processible by an ECC engine that is not designed to operate on the size of real portion 802. To overcome this issue, synthesized data 810 may be added to real portion 802 prior to input to an ECC engine. In some implementations, the synthesized data may comprise all zero or all one values. In some implementations, the size of synthesized data 810 is designed such that the total size of synthesized data 810 and real portion 802 is equal to the expected user data size of real portion 806. In this manner, the combination of real portion 802, synthesized data 810 and parity portion 804 meets the requirements of an ECC engine used by a memory device. The combination of real portion 802, synthesized data 810 and parity portion 804 is referred to a “shortened” codeword.

However, the introduction of synthesized data 810 may introduce false-positive errors detected by the ECC engine. Specifically, since the parity portion 804 is generated based on real portion 802 during encoding and then real portion 802 and synthesized data 810 are used for decoding, the parity portion 804 is no longer synchronized with the codeword. FIG. 8B illustrates this decoding problem. As illustrated, the shortened codeword is input into an ECC decoder 818. The ECC decoder may comprise, for example, an ECC2 decoder that can detect up to two errors (e.g., a BCH-2 decoder). In some implementations, the shortened codeword can be generated before input into ECC decoder 818. In other implementations, the ECC decoder 818 itself may add the synthesized data 810 to form the shortened codeword.

As illustrated by the darkened locations, real portion 802 includes three errors. Synthesized data 810 necessarily does not include true errors since it is synthesized data. However, when decoding the shortened codeword using ECC decoder 818, ECC decoder 818 detects two errors: one error in real portion 802 and an error in synthesized data 810 (also illustrated as a darkened location). Thus, ECC decoder 818 proposes to correct two errors, however one error is improper. Notably, when the ECC decoder 818 overflows, the proposed corrections may all be incorrect. Further, in some implementations, the use of synthesized data can overwhelm the ECC and thus the ECC may incorrectly detect errors in real portion 802 as well. As will be discussed, an error in synthesized data 810 can be ensured to be a sign of error overflow since no errors can exist in synthesized data 810. In general, when the number of errors overpowers the ECC, the resulting syndrome may propose to correct two errors in potentially arbitrary positions which may or may not be coherent with the actual error positions.

If the number of actual errors overpowers the ECC correction power, the probability of having two proposed corrections within the real positions can be defined probabilistically and expressed as follows:

$$\frac{real}{total} \cdot \frac{real - 1}{total - 1}$$

Here, real refers to the length of the real portion 802 and total refers to the size of the shortened codeword input into the ECC engine (e.g., real plus the size of synthesized data 810). For example, if a codeword size is 511 bits but the size of the real portion 802 is only 274 bits, the probability of the ECC correcting two true errors is as follows:

$$( \frac{274}{511} \cdot \frac{273}{510} ) \approx 28 \%$$

Thus, in such a scenario, the ECC engine will incorrectly try to correct false errors in 72% of the considered codewords (containing more than two errors). The above probability necessarily increases as the real portion 802 occupies less of the total size of shortened codeword. In all of these scenarios, the example embodiments provide techniques for resolving the coherency of detected errors given a shortened ECC codeword.

FIG. 9 is a flow diagram illustrating a method for detecting an incorrect error position in an ECC algorithm executing on an extended ECC codeword.

In step 902, the method can include receiving a codeword.

As discussed above, the codeword in step 902 can include a codeword that includes a first portion and at least one other portion. The following description utilizes a first portion and one other portion (the “second” portion); however the disclosure is not limited to a single other portion. In an implementation, the first portion can include actual data. As used herein, actual data refers to data written to a memory device or otherwise of use by a computing system. By contrast, the second portion may include synthesized data. In the implementations, the codeword also includes a parity portion generated using the first portion as input. In some implementations, the synthesized data may comprise all zeros, all ones, or a random pattern of zeros and ones. In some implementations, step 902 can be implemented within an ECC circuit or algorithm. In other implementations, step 902 can be implemented by a microcontroller or via software prior to inputting the extended codeword into an ECC circuit or algorithm.

In step 904, the method can include using an ECC engine (e.g., circuit or algorithm) to detect the positions of errors within the entire codeword.

In some implementations, the ECC engine can detect multiple bit errors. In some implementations, the ECC engine can implement an existing ECC algorithm such Single error correction/double error detection (SEC-DED) Hsiao codes, Single error correction/double error detection/single byte error detection (SEC-DED-SBD) Reddy codes, Single byte error correction/double byte error detection (SBC-DBD) finite field-based codes, Double error correction/triple error detection (DEC-TED) Bose-Chaudhuri-Hocquenghem (BCH) codes, or similar types of ECC. In general, any ECC engine that can detect error positions can be used.

In some embodiments, the method can store the positions of any errors detected in step 904. For example, the method can store the bit positions of errors relative to the codeword in a volatile storage device (e.g., DRAM) for later use (e.g., in step 908 and step 910, discussed herein).

In step 906, the method can include determining if any errors are present within the codeword. If not, the method can terminate as no error correction is needed. As illustrated, in one embodiment, the method can proceed to step 908 if even a single error is detected and of course if multiple errors are detected. As discussed in connection with FIG. 8, since the codeword received in step 902 includes synthesized data that may be all zeroes or all ones, errors may be detected both within a real portion of the keyword (including user data) or within this synthesized region. Since this synthesized region does not include actual data, errors detected within the region are false positives.

In step 908, the method can include comparing the detected error positions to the real portion positions of the codeword.

In some embodiments, the method can be configured with a mapping of real positions and synthesized positions of the codeword received in step 902. For example, in some embodiments, the method can store a length (from zero) of the real portion. Alternative, in some embodiments, the method can store a bit mapping that identifies (e.g., non-contiguous) real bits of the codeword.

The method can compare the detected error positions to a list (or range) of real bit positions in the codeword. Then, in step 910, the method can determine whether the ECC engine properly detected the errors. Specifically, in step 910, the method can determine if the detected error positions correspond to bits of real data in the codeword. For example, if the codeword includes n bits and bits zero through m comprise a real portion of the codeword (where m<n), step 910 can include determining if error bit positions (b₁, b₂, . . . bₙ) are located in bit positions between zero and m.

In some scenarios, all of the detected bit errors may be within the real portion. In this case, the method can proceed to step 912 and correct the errors. In one embodiment, step 912 can include running a correction engine of the ECC engine to correct the detected errors. The specific operations of an ECC engine are not limiting and are not discussed in detail herein. After correcting errors, the method can then return the codeword to a calling device in step 916.

By contrast, if the method determines (in step 910) that at least one error position is not in the real portion of the keyword (i.e., is in the synthesized data), the method can proceed to step 914 where it handles the ECC misdetection and miscorrection before ending. In some implementations, the method can raise a signal indicating that error correction has failed due to overwhelming of the ECC engine with the synthesized portion. Such an approach can be used in conjunction with any of the foregoing embodiments (e.g., as a flag indicating such a correction was performed). Alternatively, the signal can be raised immediately, and the method can halt, signaling remedial measures are needed. For example, a backup of the codeword can be read from a redundant memory device.

Using the above method of FIG. 9, the form of the codeword can be used to re-utilize an ECC engine for a varying length input codeword. Since an ECC engine will improperly detect errors in such an “extended” codeword (as illustrated in FIGS. 8A and 8B), the method utilizes the structure of the codeword to ensure that only valid errors are detected. Use of this structure allows for standard ECC engines to be used with variable length codewords and allows re-use of existing ECC engines, despite shortened user data.

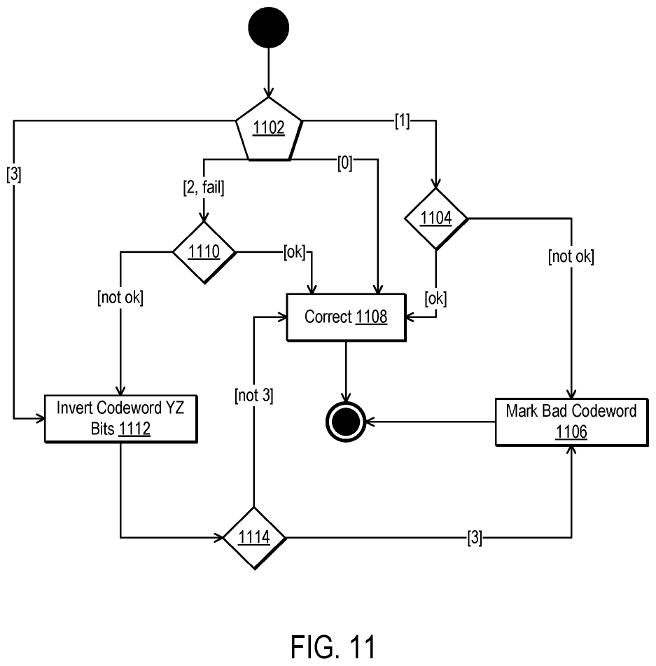

FIGS. 10 and 11 are flow diagrams illustrating a method for increasing the correction power of an ECC engine using correlations between two codewords.

The illustrated method is described in more detail below. At a high-level, the method can include receiving a codeword having a first portion and a second portion and detecting, using an ECC (e.g., ECC2) engine at least one error or failure in the first portion (step 1002). Based on the number of errors or failure of the ECC2, the method can then perform error correction on the second portion and invert zero or more bits of the first or second portions and then proceed to perform error corrections on the first and second portions (step 1024). More specifically, if the ECC on the first portion fails the method can invert bits of the first portion based on an extended ECC performed on the second portion (steps 1004, 1006, 1008). If no errors exist on the first portion, the method can perform an extended ECC operation on the second portion and mark the codeword as uncorrectable if three errors occur or correct the errors otherwise (steps 1010 and 1012). If one error in the first portion is detected, the method can employ a combination of extended ECC detection on the second portion as well as a coherency check to determine when to invert bits of the second portion (steps 1014, 1016, 1018, 1020, 1026, 1028). Finally, if two errors are detected in the first portion the method can perform an extended ECC operation on the second portion and perform alternative coherency checks to determine when to invert bits of the second portion. Details of these operations are provided herein. While the foregoing method generally describes a maximum of three errors, the method may be generalized to include more errors than three.

In step 1002, the method can begin by receiving a codeword and using an ECC engine (e.g., circuit or algorithm) to detect the positions of errors within a first portion of the codeword.

As discussed above, the codeword in step 1002 can include a codeword that includes a first portion (referred to as codeword X) and at least one other portion (referred to as codeword YZ). The following description utilizes a first portion and one other portion (the “second” portion), however the disclosure is not limited to a single other portion. In an implementation, the first portion can include actual data. As used herein, actual data refers to data written to a memory device or otherwise of use by a computing system. By contrast, the second portion may include synthesized data. In some implementations, the synthesized data may comprise all zeros, all ones, or a random pattern of zeros and ones. In some implementations, step 1002 can be implemented within an ECC circuit or algorithm. In other implementations, step 1002 can be implemented by a microcontroller or via software prior to inputting the extended codeword into an ECC circuit or algorithm.

In some implementations, the ECC engine can detect multiple bit errors. In some implementations, the ECC engine can implement an existing ECC algorithm such as Single Error Correction/Double Error Detection (SEC-DED) Hsiao codes, Single Error Correction/Double Error Detection/Single Byte Error Detection (SEC-DED-SBD) Reddy codes, Single Byte Error Correction/Double Byte Error Detection (SBC-DBD) finite field-based codes, Double Error Correction/Triple Error Detection (DEC-TED) Bose-Chaudhuri-Hocquenghem (BCH) codes, or similar types of ECC. In general, any ECC engine that can detect error positions can be used. In some implementations, step 1002 may include utilizing an ECC2 engine.

As illustrated, the method in step 1002 can detect 0, 1, or 2 errors in codeword X or can also fail, as illustrated by the branches of step 1002. In general, failing refers to an ECC algorithm detecting too many errors that it may not be capable of correcting. In some implementations, failing may also refer to detecting a correction proposed in a synthesized region of a codeword as described previously with respect to FIG. 9. Such a scenario is also referred to as overpowering or overwhelming the error correction capabilities of the ECC. An ECC algorithm or engine may include two stages: a detection stage or engine and a correction stage or engine. In the various detection steps, only the detection engine may be utilized. In some implementations, the detection engine may not be capable of identifying the specific number of errors, but simply that error overflow has occurred.

If the ECC2 engine in step 1002 fails, the method proceeds to step 1004. In step 1004, an extended ECC2 engine is applied to the second portion of the codeword (codeword YZ). As illustrated, in some implementations, the extended ECC2 engine can detect zero to three errors or may also fail, similar to the ECC2 engine discussed in step 1002. As illustrated, if the extended ECC2 engine detects one or two errors in codeword YZ, the method proceeds to step 1006 (described next). However, if the extended ECC2 engine detect no errors, three errors, or fails, the method marks the entire codeword (e.g., both codeword X and codeword YZ) as uncorrectable in step 1008 and fails.

In step 1006, the method has determined that one or two errors are present in codeword YZ. In response, the method inverts one or more corresponding bits in codeword X. Specifically, in some implementations, the method identifies which bits in codeword YZ are associated with detected errors and inverts the corresponding codeword X bits. As discussed above, a given bit in codeword YZ may correspond (e.g., based on addressing) to a corresponding bit in codeword X. Thus, the extended ECC2 engine may indicate the address of the errors in codeword YZ and this address can be used to identify the corresponding bits in codeword X that should be inverted.

As illustrated, after the bits of codeword X are inverted in step 1006, the method proceeds to step 1024 where the codeword is corrected using an appropriate ECC engine. Specifically, an ECC2 engine is used to correct codeword X (with bit inversions applied in step 1006) while the extended ECC2 engine is used to correct codeword YZ. Notably in step 1024 the actual error correction is performed.

Returning to step 1002, in another scenario, the ECC2 engine of step 1002 may not detect any errors in codeword X. In this scenario, the method proceeds to step 1010. In step 1010, the method uses an extended ECC2 engine to detect errors in codeword YZ. As in step 1004, the method in step 1010 include detecting zero to three errors (or in some implementations zero to two errors) or failing. However, in step 1010, the method can include determining whether the detected number of errors is equal or not to three. If the extended ECC2 engine detects three errors (and in some implementations if the check fails), the method proceeds to step 1012. In step 1012, the method (as in step 1008) marks the entire codeword as uncorrectable and fails. By contrast, if less than three errors are detected (or the extended ECC2 fails), the method proceeds to step 1024 where the codeword is corrected using an appropriate ECC engine. Specifically, an ECC2 engine is used to correct codeword X while the extended ECC2 engine is used to correct codeword YZ. Notably in step 1024 the actual error correction is performed.

Returning to step 1002, in another scenario, the ECC2 engine of step 1002 may detect a single error in codeword X. In response to detecting a single error in codeword X, the method may perform an extended ECC operation on the second portion in step 1014. If the extended ECC operation in step 1014 indicates zero or one error, the method may proceed to 1026 where the codeword is corrected using an appropriate ECC engine. Specifically, an ECC2 engine is used to correct codeword X while the extended ECC2 engine is used to correct codeword YZ. Notably in step 1026 the actual error correction is performed.

By contrast, if the extended ECC operation in step 1014 indicates three errors (and in some implementations if the extended ECC operation fails), the method may proceed to step 1020 where bits of codeword YZ are inverted based on the detected errors in codeword X. Specifically, in some implementations, the method identifies which bits in codeword X are associated with detected errors and inverts the corresponding codeword YZ bits. As discussed above, a given bit in codeword X may correspond (e.g., based on addressing) to a corresponding bit in codeword YZ. Thus, the ECC2 engine may indicate the address of the errors in codeword X and this address can be used to identify the corresponding bits in codeword YZ that should be inverted. After performing this inversion in step 1020, the method proceeds to step 1022 where a second extended ECC operation is performed on the second portion (codeword YZ). Here, if the second extended ECC operation indicates three errors, the method proceeds to step 1018 and marks the codeword as uncorrectable (similar to step 1008 or 1012, discussed previously). By contrast, if the second extended ECC operation yields any other result (e.g., zero to two errors or a failure), the method proceeds to step 1028 where the codeword portions are corrected (similar to step 1024 and step 1026).

Finally, in some scenarios, the extended ECC operation in step 1014 may either fail or indicate two errors. In this scenario, the method proceeds to step 1016 where a coherency check is performed. As used herein, a coherency check refers to a logical test that yields an OK or not OK value (e.g., pass or fail). In some implementations, the OK value can be determined by determining if at least one error in the second portion (codeword YZ) matches with at least one error in the first portion (codeword X). By contrast, a not OK value can be returned if the error locations in the second portion (codeword YZ) are different from the error locations in the first portion (codeword X). This coherency check can thus be used to leverage the relation between codeword portions to quickly confirm or reject errors. If the coherency check passes, the method can correct the codewords in step 1026 as described above. By contrast, if the coherency check fails, the method can mark the codeword as uncorrectable in step 1018 as described previously.

Returning to step 1002, the final scenario, the ECC2 engine of step 1002 may detect two errors in codeword X. In this scenario, step 1030 may be performed on codeword YZ, as will be described next herein with respect to the steps of FIG. 11.

Turning to FIG. 11, this method may be called when the method of FIG. 10 detects two errors in the first portion of the codeword (codeword X). In step 1102, the method can include applying an extended ECC error correction operation to the second portion of the codeword (codeword YZ).

In a first scenario, the method may detect no errors in the second portion of the codeword. In this scenario, the method proceeds to step 1108 where the errors in the codeword are corrected. In some implementations the codeword can be corrected using an appropriate ECC engine. Specifically, an ECC2 engine is used to correct codeword X while the extended ECC2 engine is used to correct codeword YZ. Notably in step 1108 the actual error correction is performed.

In another scenario, the method may detect a single error in the second portion of the codeword. In this scenario, the method performs a coherency check in step 1104. As with step 1016, this coherency check may return an OK or not OK value based on comparing the positions of errors in each portion of the codeword. Details of the coherency check are the same as those in step 1016 and not repeated herein. If the coherency check passes (i.e., yields an OK value), the method proceeds to step 1108 and corrects the errors in the codeword. Step 1108 is described above and not repeated herein. By contrast, if the coherency check fails (not OK), the method proceeds to step 1106 and marks the codeword as uncorrectable.

In a third scenario, the method may detect two errors in the second portion of the codeword or may alternatively fail. In this scenario, the method can proceed to step 1110 where a second coherency check is performed on the codeword portions (identical to that described in step 1104). If the coherency check passes (OK), the method proceeds to step 1108 and corrects the errors in the codeword. Step 1108 is described above and not repeated herein. By contrast, if the coherency check fails (not OK), the method proceeds to step 1112, described herein.

Finally, if the extended ECC operation in step 1102 indicates three errors (and in some implementations if the extended ECC operation fails), or if the coherency check in step 1110 fails, the method may proceed to step 1112 where bits of codeword YZ are inverted based on the detected errors in codeword X. Specifically, in some implementations, the method identifies which bits in codeword X are associated with detected errors and inverts the corresponding codeword YZ bits. As discussed above, a given bit in codeword X may correspond (e.g., based on addressing) to a corresponding bit in codeword YZ. Thus, the ECC2 engine may indicate the address of the errors in codeword X and this address can be used to identify the corresponding bits in codeword YZ that should be inverted. After performing this inversion in step 1112, the method proceeds to step 1114 where a second extended ECC operation is performed on the second portion (codeword YZ). Here, if the second extended ECC operation indicates three errors, the method proceeds to step 1106 and marks the codeword as uncorrectable. By contrast, if the second extended ECC operation yields any other result (e.g., zero to two errors or, optionally, a failure), the method proceeds to step 1108 where the codeword portions are corrected (as discussed previously).

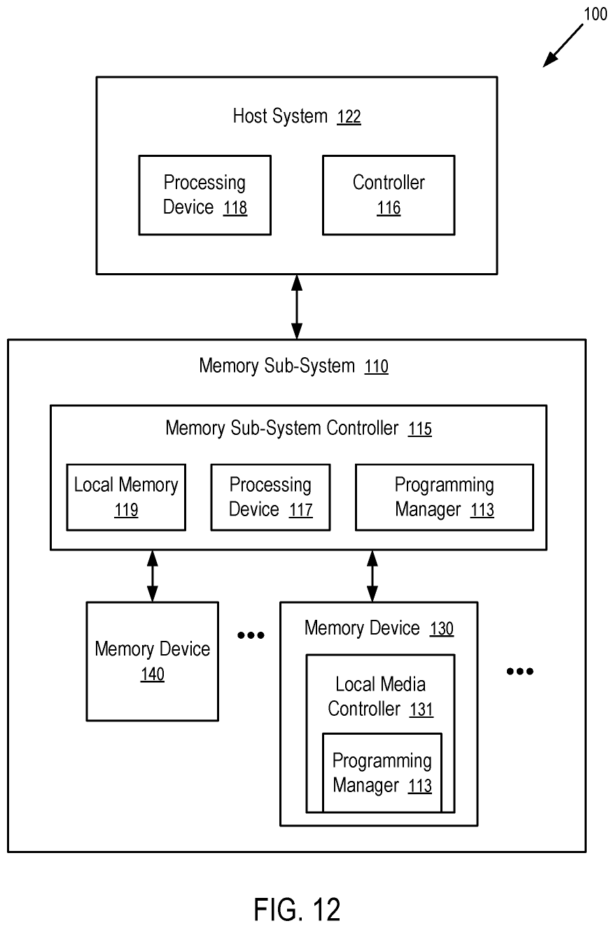

FIG. 12 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130 of FIG. 1), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or such a computing device that includes memory and a processing device.

The computing system 100 can include a host system 122 that is coupled to one or more memory sub-systems 110. FIG. 12 illustrates one example of a host system 122 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 122 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 122 uses the memory sub-system 110, for example, to write data to the memory sub-system 110 and read data from the memory sub-system 110.

The host system 122 can be coupled to the memory sub-system 110 via a physical host interface. Examples of a physical host interface include, but are not limited to, a serial advanced technology attachment (SATA) interface, a peripheral component interconnect express (PCIe) interface, a universal serial bus (USB) interface, a Fibre Channel, a Serial Attached SCSI (SAS) interface, a double data rate (DDR) memory bus interface, a Small Computer System Interface (SCSI), a dual in-line memory module (DIMM) interface (e.g., DIMM socket interface that supports Double Data Rate (DDR)), an Open NAND Flash Interface (ONFI), a Double Data Rate (DDR) interface, a Low Power Double Data Rate (LPDDR) interface, or any other interface. The physical host interface can be used to transmit data between the host system 122 and the memory sub-system 110. The host system 122 can further utilize an NVM Express (NVMe) interface to access components (e.g., memory devices 130 of FIG. 1) when the memory sub-system 110 is coupled with the host system 122 by the PCIe interface. The physical host interface can provide an interface for passing control, address, data, and other signals between the memory sub-system 110 and the host system 122. FIG. 12 illustrates a memory sub-system 110 as an example. In general, the host system 122 can access multiple memory sub-systems via a same communication connection, multiple separate communication connections, and/or a combination of communication connections.

The processing device 118 of the host system 122 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 122 and the memory sub-system 110. In general, the controller 116 can send commands or requests to the memory sub-system 110 for desired access to memory devices 130, 140. The controller 116 can further include interface circuitry to communicate with the memory sub-system 110. The interface circuitry can convert responses received from memory sub-system 110 into information for the host system 122.

The controller 116 of the host system 122 can communicate with controller 115 of the memory sub-system 110 to perform operations such as reading data, writing data, or erasing data at the memory devices 130, 140 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 130, 140 can include any combination of the different types of non-volatile memory components and/or volatile memory components. The volatile memory devices (e.g., memory device 140) can be, but are not limited to, random access memory (RAM), such as dynamic random-access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (e.g., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (e.g., processor) configured to execute instructions stored in a local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 122.

In some embodiments, the local memory 119 can include memory registers storing memory pointers, fetched data, etc. The local memory 119 can also include read-only memory (ROM) for storing micro-code. While the example memory sub-system 110 in FIG. 12 has been illustrated as including the controller 115, in another embodiment of the present disclosure, a memory sub-system 110 does not include a controller 115, and can instead rely upon external control (e.g., provided by an external host, or by a processor or controller separate from the memory sub-system).

In general, the controller 115 can receive commands or operations from the host system 122 and can convert the commands or operations into instructions or appropriate commands to achieve the desired access to the memory devices 130. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The controller 115 can further include host interface circuitry to communicate with the host system 122 via the physical host interface. The host interface circuitry can convert the commands received from the host system into command instructions to access the memory devices 130 as well as convert responses associated with the memory devices 130 into information for the host system 122.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory devices 130.

In some embodiments, the memory devices 130 include local media controllers 131 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 131) for media management within the same memory device package. An example of a managed memory device is a managed NAND (MNAND) device.

The controller 115 and/or a memory device 130 can include a programming manager 113, such as the programming manager 113 discussed above in connection with FIGS. 1 to 6. In some embodiments, the controller 115 in the memory sub-system 110 includes at least a portion of the programming manager 113. In other embodiments, or in combination, the controller 116 and/or the processing device 118 in the host system 122 includes at least a portion of the programming manager 113. For example, the controller 115, the controller 116, and/or the processing device 118 can include logic circuitry implementing the programming manager 113. For example, the controller 115, or the processing device 118 (e.g., processor) of the host system 122, can be configured to execute instructions stored in memory for performing the operations of the programming manager 113 described herein. In some embodiments, the programming manager 113 is implemented in an integrated circuit chip (e.g., memory device 130) installed in the memory sub-system 110. In other embodiments, the programming manager 113 can be part of firmware of the memory sub-system 110, an operating system of the host system 122, a device driver, or an application, or any combination therein.

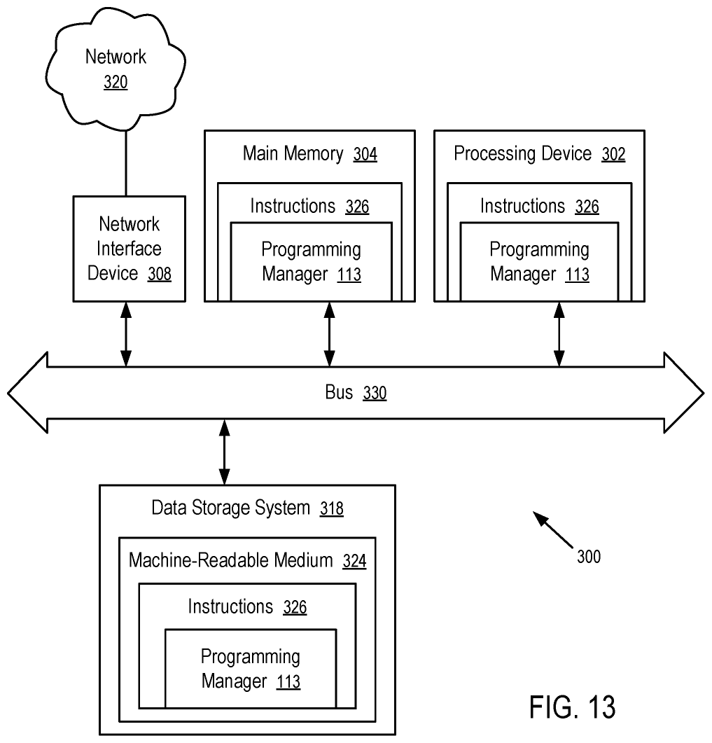

FIG. 13 illustrates an example machine of a computer system 300 within which a set of instructions, for causing the machine to perform any one or more of the methodologies discussed herein, can be executed. In some embodiments, the computer system 300 can correspond to a host system (e.g., the host system 122 of FIG. 12) that includes, is coupled to, or utilizes a memory sub-system (e.g., the memory sub-system 110 of FIG. 12) or can be used to perform the operations of a programming manager 113 (e.g., to execute instructions to perform operations corresponding to the programming manager 113 described with reference to FIGS. 12 and 13). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 300 includes a processing device 302, a main memory 304 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 318, which communicate with each other via a bus 330 (which can include multiple buses).

Processing device 302 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 302 can also be one or more special-purpose processing devices such as an application specific integrated circuit (ASIC), a field programmable gate array (FPGA), a digital signal processor (DSP), network processor, or the like. The processing device 302 is configured to execute instructions 326 for performing the operations and steps discussed herein. The computer system 300 can further include a network interface device 308 to communicate over the network 320.

The data storage system 318 can include a machine-readable medium 324 (also known as a computer-readable medium) on which is stored one or more sets of instructions 326 or software embodying any one or more of the methodologies or functions described herein. The instructions 326 can also reside, completely or at least partially, within the main memory 304 and/or within the processing device 302 during execution thereof by the computer system 300, the main memory 304 and the processing device 302 also constituting machine-readable storage media. The machine-readable medium 324, data storage system 318, and/or main memory 304 can correspond to the memory sub-system 110 of FIG. 12.

In one embodiment, the instructions 326 include instructions to implement functionality corresponding to a programming manager 113 (e.g., the programming manager 113 described with reference to FIGS. 1-6). While the machine-readable medium 324 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

We claim:

1. A method comprising:
receiving a codeword having a first portion and a second portion;
detecting, using an ECC engine, an error at a first position in the codeword; and
signaling an error misdetection when the first position is within the second portion.

2. The method of claim 1, wherein the second portion includes all ones or all zeroes.

3. The method of claim 1, wherein the second portion includes random data.

4. The method of claim 1, wherein determining if the first position is within the first portion comprises determining if the first position is less than a length of the first portion.

5. The method of claim 1, wherein detecting at least one error in the codeword at a first position comprises detecting two errors in the codeword and correcting the two errors if the two errors are in the first portion.

6. The method of claim 1, wherein the codeword comprises a BCH codeword.

7. The method of claim 6, wherein the BCH codeword includes a parity portion generated based on the first portion.

8. A method comprising:
receiving a message having a first codeword and a second codeword;
detecting an error in a position of the first codeword using a first ECC engine;
analyzing the second codeword to detect positions of errors within the second codeword using a second ECC engine;
inverting at least one bit of the second codeword based on the positions of errors within the second codeword and the position; and
correcting the message.

9. The method of claim 8, wherein the first ECC engine and second ECC engine comprise a single ECC engine.

10. The method of claim 8, wherein the method further comprises:
performing a coherency check on the first codeword and second codeword;
marking the message as uncorrectable if the coherency check fails; and
correcting the message if the coherency check passes.

11. The method of claim 8, wherein analyzing the second codeword comprises detecting three error positions by the second ECC engine.

12. The method of claim 11, wherein the method further comprises:
inputting the second codeword into the second ECC engine to detect second positions of errors; and
correcting the message when a number of the second positions of errors is less than three.

13. A method comprising:
receiving a message comprising first codeword and a second codeword;
detecting two errors in first positions of the first codeword;
analyzing the second codeword to detect positions of errors within the second codeword; and
correcting the message based on the first positions and the positions of errors within the second codeword.

14. The method of claim 13, wherein analyzing the second codeword to detect positions of errors within the second codeword comprises detecting one error and the method further comprises performing a coherency check on the second codeword, wherein the method corrects the message when the coherency check passes and marks the message as uncorrectable when the coherency check fails.

15. The method of claim 13, wherein analyzing the second codeword to detect positions of errors within the second codeword comprises detecting no errors.

16. The method of claim 13, wherein analyzing the second codeword to detect positions of errors within the second codeword comprises detecting two errors or a failure of an ECC engine, the method further comprising:
performing a coherency check on the second codeword;
correcting the message when the coherency check passes; and
inverting at least one bit of the second codeword based on the positions of errors within the second codeword and the first positions when the coherency check fails.

17. The method of claim 16, wherein the method further comprises inputting the second codeword into the ECC engine and correcting the message if a number of errors detected by the ECC engine is less than three.

18. The method of claim 13, wherein analyzing the second codeword to detect positions of errors within the second codeword comprises detecting three errors, the method further comprising:
inverting at least one bit of the second codeword based on the positions of errors within the second codeword and the first positions; and
inputting the second codeword into a second ECC engine and correcting the second codeword if a number of errors detected by the second ECC engine is less than three.

19. A method comprising:
receiving a message, the message having a first codeword and a second codeword;
detecting, using a first ECC engine, that an error detection has failed when analyzing the first codeword;
analyzing, using a second ECC engine, the second codeword to detect positions of errors within the second codeword;
inverting at least one bit of the first codeword based on the positions of errors within the second codeword and the at least one position; and
correcting the message using the first ECC engine and second ECC engine.

20. The method of claim 19, wherein the first ECC engine comprises an ECC2 engine.
